(19) United States
(12) Patent Application Publication
(10) Pub. No.: US 2017/0206882 A1
(43) Pub. Date: Jul. 20, 2017

(54) Method for Producing Acoustic Damping Elements

(71) Applicant: Sennheiser electronic GmbH & Co. KG, Wedemark (DE)

(72) Inventors: Benjamin ROSS, Stadthagen (DE); Robert KONETZKY, Seelze (DE); Burkhard MARKMANN, Langenhagen (DE)

(73) Assignee: Sennheiser electronic GmbH & Co. KG, Wedemark (DE)

(21) Appl. No.: 15/328,243

(22) PCT Filed: Jul. 24, 2015
(86) PCT No.: PCT/EP2015/067034

§ 371 Date: Jan. 23, 2017

(30) Foreign Application Priority Data
Jul. 24, 2014 (DE) 10 2014 214 547.3

(51) Int. Cl. G10K 11/00; B26F 1/02; H04R 1/28

(52) U.S. Cl. CPC G10K 11/002; H04R 1/2876; B26F 1/02

(57) ABSTRACT

There is provided a method of producing acoustic damping elements having an acoustic resistance. For that purpose at least one sleeve with a hole having a diameter is placed below a base material. At least one hole is stamped in the base material by at least one punch having a punch diameter. The punching operation is repeated at various positions on the base material.

The present application claims priority from International Patent Application No. PCT/EP2015/067034 filed on Jul. 24, 2015, which claims priority from German Patent Application No. 10 2014 214 547.3 filed on Jul. 24, 2014, the disclosures of which are incorporated herein by reference in their entirety.

### FIELD OF THE INVENTION

It is noted that citation or identification of any document in this application is not an admission that such document is available as prior art to the present invention.

The invention concerns a method of producing acoustic damping elements.

Acoustic damping elements with acoustic resistances are used in many various electroacoustic devices like for example headphones, microphones, headsets, sound transducers and so forth. Acoustic resistances can be made from paper, fleece, cloth, foam, hole structures, plastic, metal and silks. Those materials can have different acoustic resistances. An acoustic resistance can be set for example by the provision of holes in the material used. The holes can be for example lasered into the material or etched into the material. As an alternative thereto the holes can also be bored into the corresponding material.

In the methods used hitherto however reproducibility, manufacturing costs and contamination as well as the process duration are disadvantages.

In the German patent application from which priority is claimed the German Patent and Trade Mark Office searched the following documents: AT 66177 E (or E 66177 B) and EP 1 234 922 A1.

### SUMMARY OF THE INVENTION

Therefore an object of the present invention is to provide a method of producing acoustic damping elements, which permits good reproducibility and an exact repeatable hole geometry which is accurate in form, with high precision.

Thus there is provided a method of producing an acoustic damping element for a microphone, an earphone or a loudspeaker. The damping element has an acoustic resistance which has been established in advance. For that purpose at least one sleeve with a hole having a diameter is placed below a base material. At least one hole is stamped in the base material by at least one punch having a punch diameter. The punching operation is repeated at various positions on the base material until the previously established acoustic resistance is attained. The diameter of the holes in the base material is between 30 μm and 350 μm.

According to an aspect of the present invention the diameter of the hole is dependent on the diameter of the punch, the diameter of the bore in the sleeve, the material thickness and the base material.

According to a further aspect of the present invention production of the acoustic resistance can involve using a multi-purpose tool which has a plurality of punches and a plurality of sleeves.

The invention also concerns an acoustic resistance which is or can be produced in accordance with one of the above-described methods.

The invention also concerns an electroacoustic device having an acoustic resistance which has been produced in accordance with one of the above-described methods.

The invention also concerns the use of a machine for the production of the conducting connection between a plurality of copper layers in circuit boards for producing an acoustic resistance. In that case at least one sleeve with a hole having a diameter is placed below a base material and at least one hole is stamped in the base material by the at least one punch having a punch diameter. The stamping operation can be repeated a plurality of times at different positions. The diameter of the hole in the base material is between 30 μm and 350 μm.

The invention concerns the notion of stamping the holes in the acoustic material. For that purpose a sleeve having a first diameter is placed below the material and then a plurality of holes is stamped by a punch having a second diameter. Stamping the holes makes it possible to permit holes of a reproducible diameter with a very small tolerance. In addition the acoustic resistances can be produced very rapidly.

The stamping method according to the invention for the production of acoustic resistances or an acoustic damping can permit a very tight tolerance field. The acoustic resistances can be produced individually and only a very short development or processing time is required as the number of iteration steps for the production of a given acoustic resistance involving the required accuracy is markedly reduced.

Production of the acoustic resistances with the corresponding holes can be repeated and is uniform. The wastage during the production method is considerably reduced and the acoustic resistances can be flexibly adapted to the product geometries in which they are to be used. According to the invention holes which have a tolerance in the micrometer range can be provided in the acoustic material used.

According to the invention the hole diameter is dependent on the punch diameter, the sleeve inside diameter, the material thickness and the nature of the material which is to be used as the acoustic resistance.

According to the invention the acoustic damping element is provided in microphones, earphones or loudspeakers.

### BRIEF DESCRIPTION OF THE DRAWINGS

FIG. 1 shows a diagrammatic cross-section of an electroacoustic transducer according to the invention.

FIG. 2 shows a diagrammatic view of a method of producing acoustic damping units with acoustic resistances.

FIG. 3 shows various holes in acoustic materials which are achieved by different methods.

### DETAILED DESCRIPTION OF EMBODIMENTS

It is to be understood that the figures and descriptions of the present invention have been simplified to illustrate elements that are relevant for a clear understanding of the present invention, while eliminating, for purposes of clarity, many other elements which are conventional in this art. Those of ordinary skill in the art will recognize that other elements are desirable for implementing the present invention. However, because such elements are well known in the art, and because they do not facilitate a better understanding of the present invention, a discussion of such elements is not provided herein.

The present invention will now be described in detail on the basis of exemplary embodiments.

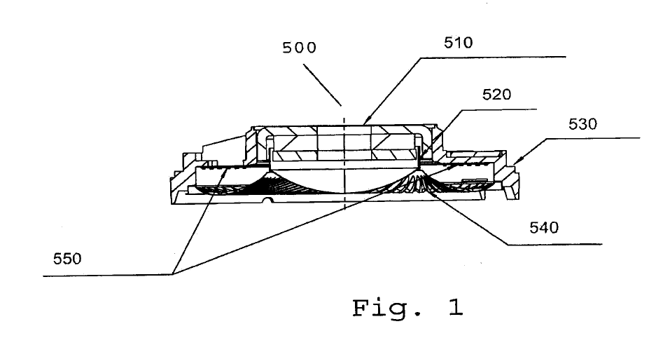

FIG. 1 shows a diagrammatic cross-section of an electroacoustic transducer according to the invention. The transducer is for example in the form of a headphone capsule. An acoustic damping element can be fitted in the headphone capsule. The current-carrying coil 520 vibrates freely within a magnetic field produced by the magnet system 510 and thus drives the diaphragm 540 fixedly connected thereto. By virtue of its mass and the spring stiffness of the diaphragm 540 the system forms a freely vibrating spring-mass system which has to be damped. That is effected by the acoustic damping 550 which is disposed above the diaphragm 540 and which is typically implemented by a perforated film.

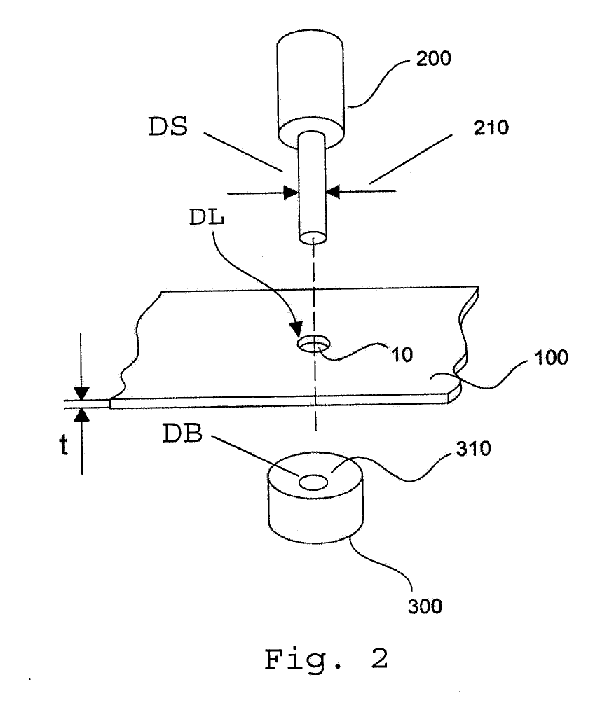

FIG. 2 shows a diagrammatic view of a method of producing acoustic resistances. To produce acoustic resistances for the damping element, a base material 100 is employed and a plurality of holes 10 is stamped in that base material. The operation of stamping the holes 10 is effected by means of a punch 200 having a first diameter DS and a sleeve 300 with a bore 310 having a second diameter DB. The sleeve 310 is placed beneath the base material 100 and the punch 200 moves through the base material 100 into the sleeve 300 and in so doing stamps a hole 10 in the base material. That step is repeated at various positions until the desired acoustic resistance is attained. For that purpose the tool (stamp/sleeve) and/or the material can be selectively re-positioned. Preferably a uniform arrangement (for example a square pattern) is applied in that case.

According to the invention the diameter DL of the hole 10 depends on the diameter DS of the punch, the diameter DB of the sleeve 300, the material thickness t and the material of the base material.

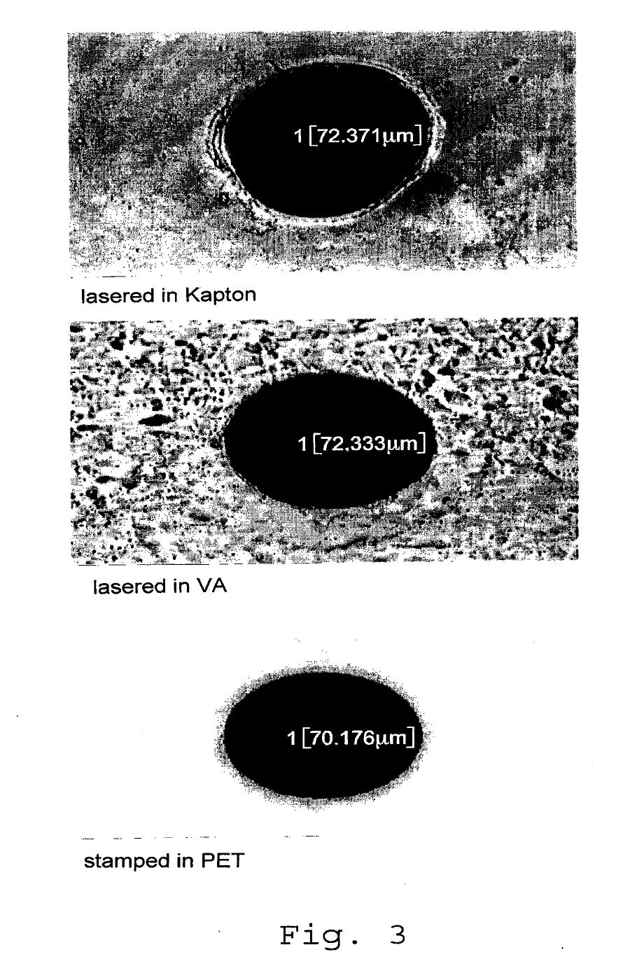

FIG. 3 shows three holes in acoustic material, which are produced by different methods. The uppermost part of the Figure shows a lasered hole in Kapton. The middle part of the Figure shows a lasered hole in VA steel. The lower part of the Figure shows a hole which is stamped in a PET film and which has been produced by the stamping method according to the invention. It can be seen from these views that the method according to the invention is advantageous as it permits precise production of the required holes. It is possible with the production method according to the invention to provide the hole diameter in highly accurate and uniform fashion.

In particular the burr (that is to say the raised material at the edge of the hole) and the indent (that is to say the inward inclination at the edge of the hole) with the method according to the invention are very slight but very uniform (among the various holes). This contributes to the reproducibility of the method. That precision in terms of hole edge sharpness is of great advantage in the use of damping materials in acoustic transducers as each raised portion or inward inclination at the edge of the holes leads to acoustic distortions and the acoustic quality of the transducer would be adversely affected thereby.

It is only with the stamping method according to the invention that it is possible for the holes in the base material to be made sufficiently round. As can be seen from FIG. 3 a lasered hole is not sufficiently round.

In order to provide for example an acoustic resistance of 40 ohms the hole spacing can be selected at 795 μm, the hole diameter at 295 μm, the punch diameter at 300 μm, the sleeve diameter at 311 μm, the material thickness at 115 μm and the base material in the form of PC film (for example a polycarbonate film). The resulting stamped holes are of a diameter of 295 μm±1 μm. The acoustic resistance is then between 39 and 40 ohms.

The stamped holes are of a diameter of between 30 μm and 5 mm.

The tool used for production of the acoustic resistances can represent a tool having multiple applications, that is to say with a plurality of punches and a plurality of sleeves.

Optionally the tool used according to the invention for the production of acoustic resistances can represent a tool which is used in the semiconductor industry for the production of conducting connections (so-called “vias”, from the Latin “way”) between a plurality of copper layers in printed circuit boards (PCBs).

The base material can represent for example paper, fleece, cloth, foam, hole structures, plastic, metal or silks. Preferably a suitable PET film or a PC film can be used.

According to the invention the acoustic resistances produced according to the invention can be used in electroacoustic devices like for example earphones, microphones or sound transducers.

1. A method of producing an acoustic damping element for a microphone, an earphone, or a loudspeaker, wherein the damping element has a predetermined acoustic resistance, comprising the steps:
placing at least one sleeve, with a bore having a diameter, below a base material;
punching at least one hole in the base material by at least one punch having a punch diameter; and
repeating the punching operation at different positions on the base material until the predetermined acoustic resistance is attained;
wherein diameters of the holes punched in the base material are between 30 μm and 350 μm.

2. The method as set forth in claim 1;
wherein the diameters of the holes punched in the base material depend on the diameter of the punch, the diameter of the bore in the sleeve, a base-material thickness, and the base material itself.

3. The method as set forth in claim 1;
wherein a multi-purpose tool that has a plurality of punches and a plurality of sleeves is used to stamp the at least one hole.

4. An acoustic resistance produced by the method as set forth in claim 1.

5. An electroacoustic device comprising:
at least one acoustic damping element produced by the method as set forth in claim 1.

6. A method comprising:
utilizing a circuit-board conducting-connection-production machine to produce an acoustic damping element;
wherein at least one sleeve with a bore having a diameter is placed below a base material;
wherein at least one hole is punched in the base material by at least one punch having a punch diameter; and
wherein a diameter of the hole punched in the base material is between 30 μm and 350 μm.
